(19) United States
(12) Patent Application Publication
(10) Pub. No.: US 2025/0179935 A1
(43) Pub. Date: Jun. 5, 2025

(54) TURBINE SHROUD ASSEMBLY WITH PINNED TURBINE SHROUD AND VANE WITH PIN RETAINER

(71) Applicant: Rolls-Royce Corporation, Indianapolis, IN (US)

(72) Inventors: David J. Thomas, Indianapolis, IN (US); Ted J. Freeman, Indianapolis, IN (US); Aaron D. Sippel, Indianapolis, IN (US); Clark Snyder, Indianapolis, IN (US)

(21) Appl. No.: 18/528,734

(22) Filed: Dec. 4, 2023

(51) Int. Cl. F01D 25/24

(52) U.S. Cl. CPC F01D 25/24; F05D 2230/60; F05D 2260/30

(57) ABSTRACT

A turbine assembly adapted for use with a gas turbine engine includes a turbine shroud assembly and a turbine vane. The turbine shroud assembly includes a blade track segment arranged circumferentially at least partway around an axis of the gas turbine engine, a carrier segment arranged circumferentially at least partway around the axis, and a mount assembly configured to couple the blade track segment to the carrier segment. The turbine vane is located axially aft of the turbine shroud assembly and helps retain the mount assembly in place.

### FIELD OF DISCLOSURE

The present disclosure relates generally to gas turbine engines, and more specifically to subassemblies of gas turbine engines including ceramic matrix composite materials.

### BACKGROUND

Gas turbine engines are used to power aircraft, watercraft, power generators, and the like. Gas turbine engines typically include a compressor, a combustor, and a turbine. The compressor compresses air drawn into the engine and delivers high pressure air to the combustor. In the combustor, fuel is mixed with the high pressure air and is ignited. Products of the combustion reaction in the combustor are directed into the turbine where work is extracted to drive the compressor and, sometimes, an output shaft. Left-over products of the combustion are exhausted out of the turbine and may provide thrust in some applications.

Compressors and turbines typically include alternating stages of static vane assemblies and rotating wheel assemblies. The rotating wheel assemblies include disks carrying blades around their outer edges. When the rotating wheel assemblies turn, tips of the blades move along blade tracks included in static shrouds that are arranged around the rotating wheel assemblies.

Some shrouds positioned in the turbine may be exposed to high temperatures from products of the combustion reaction in the combustor. Such shrouds sometimes include blade track components made from ceramic matrix composite materials designed to withstand high temperatures. In some examples, coupling ceramic matrix composite components with traditional arrangements may present problems due to thermal expansion and/or material properties of the ceramic matrix composite components.

### SUMMARY

The present disclosure may comprise one or more of the following features and combinations thereof.

A turbine assembly adapted for use with a gas turbine engine may include a turbine shroud assembly and a turbine vane. The turbine vane may be located axially aft of the turbine shroud assembly.

In some embodiments, the turbine shroud assembly may include a blade track segment made of ceramic matrix composite materials, a carrier segment made of metallic materials, and a mount assembly. The blade track segment may be arranged circumferentially at least partway around an axis. The carrier segment may be arranged circumferentially at least partway around the axis. The mount assembly may couple the blade track segment to the carrier segment.

In some embodiments, the blade track segment may include a shroud wall and an attachment feature. The shroud wall may extend circumferentially at least partway around the axis to define a portion of a gas path of the turbine assembly. The attachment feature may extend radially outward from the shroud wall.

In some embodiments, the carrier segment may include an outer wall, a forward support wall, and an aft support wall. The outer wall may extend radially inward from the outer wall axially forward of the attachment feature, and an aft support wall that extends radially inward from the outer wall axially aft of the attachment feature, and

In some embodiments, the mount assembly may include a first retainer and a first plug. The first retainer may extend axially into a first installation aperture formed in the aft support wall of the carrier segment, through the attachment feature, and into the forward support wall to couple the blade track segment to the carrier segment. The first plug may be press fit into the first installation aperture aft of the first retainer to block removal of the first retainer through the first installation aperture in the carrier segment.

In some embodiments, the turbine vane may include an airfoil and a platform. The airfoil may extend radially across the gas path of the turbine section. The platform may extend away from the airfoil to define a portion of the gas path of the turbine assembly.

In some embodiments, a portion of the platform of the turbine vane may extend away from the airfoil toward the turbine shroud assembly to confront the first plug. The portion of the platform may confront the first plug so that the portion of the platform engages the first plug when the first plug begins to move out of the first installation aperture to block complete axial removal of the first plug out of the first installation aperture in the carrier segment.

In some embodiments, the platform of the turbine vane may include an outer end wall and a flange. The outer end wall may extend circumferentially and axially away from the airfoil to define the portion of the gas path of the turbine assembly. The flange may extend axially forward from the outer end wall toward the turbine shroud assembly radially outward of the gas path and confronts the first plug so that the flange engages the first plug when the first plug begins to move out of the first installation aperture to block complete axial removal of the first plug out of the first installation aperture in the carrier segment.

In some embodiments, the mount assembly may further includes a second retainer and a second plug. The second retainer may extend axially into a second installation aperture formed in the aft support wall of the carrier segment, through the attachment feature, and into the forward support wall. The second first plug may be press fit into the second installation aperture aft of the second retainer to block removal of the second retainer through the second installation aperture in the carrier segment. The second retainer may be spaced apart circumferentially from the first retainer. The flange of the platform may extend circumferentially at least partway about the axis and confronts the second plug so that the flange engages the second plug when the second plug begins to move out of the second installation aperture to block complete axial removal of the second plug out of the second installation aperture in the carrier segment.

In some embodiments, the first plug includes a head and a shaft. The head may engage the aft support wall of the carrier to locate the first plug relative to the first retainer. The shaft may extend axially from the head into the first installation aperture in the aft support wall to block removal of the first retainer through the first installation aperture.

In some embodiments, the first retainer may have a first diameter. The shaft of the first plug may have a second diameter. The second diameter may be greater than the first diameter of the first retainer.

In some embodiments, the aft support wall of the carrier segment may include an axially-extending wall member and a wall boss. The axially-extending wall member may extend axially inward from the outer wall. The wall boss may extend axially aft away from the axially-extending wall member. The head of the first plug may engage the wall boss to space the head of the first plug axially away from an axially aft facing surface of the axially-extending wall member.

In some embodiments, the head of the first plug may have a rectangular cross-section. The shaft of the first plug may have a circular cross-section.

In some embodiments, the attachment feature of the blade track segment may include a first attachment flange and a second attachment flange. The first attachment flange may extend radially outward from the shroud wall. The second attachment flange may extend radially outward from the should wall. The second attachment flange may be spaced apart axially from the first attachment flange.

In some embodiments, the carrier segment may further include a first intermediate support wall and a second intermediate support wall. The first intermediate support wall may extend radially inward from the outer wall of the carrier segment axially aft of the first attachment flange so that the first attachment flange is located in a forward space between the forward support wall and the first intermediate support wall. The second intermediate support wall may extend radially inward from the outer wall of the carrier segment axially forward of the second attachment flange so that the second attachment flange is located in an aft space between the aft support wall and the second intermediate support wall. The first retainer may extend into the aft support wall of the carrier segment, through the second attachment feature, the second intermediate support wall, the first intermediate support wall, the first attachment feature, and into the forward support wall to couple the blade track segment to the carrier segment.

In some embodiments, the first retainer may include a forward pin and an aft pin. The forward pin may extend axially into the forward support wall, through the first attachment flange, and through the first intermediate support wall. The aft pin may be arranged axially aft of the forward pin. The second pin may extend axially through the second intermediate support flange, through the second attachment flange, and into the aft support wall.

According to another aspect of the present disclosure, a turbine assembly adapted for use with a gas turbine engine may include a turbine shroud assembly and a turbine vane. The turbine vane may be located adjacent to the turbine shroud assembly.

In some embodiments, the turbine shroud assembly may include a blade track segment, a carrier segment, and a mount assembly. The blade track segment may be arranged circumferentially at least partway around an axis to define a portion of a gas path of the turbine assembly. The carrier segment may be arranged circumferentially at least partway around the axis. The mount assembly may be configured to couple the blade track segment to the carrier segment.

In some embodiments, the mount assembly may include a first retainer and a first plug. The first retainer may extend axially into the blade track segment and the carrier segment to couple the blade track segment to the carrier segment. The first plug may be fit into a first installation aperture in the carrier segment to block removal of the first retainer through the first installation aperture in the carrier segment.

In some embodiments, the turbine vane may include an airfoil and a platform. The airfoil may extend radially across the gas path of the turbine assembly. The platform may extend away from the airfoil to define a portion of the gas path of the turbine assembly.

In some embodiments, a portion of the platform of the turbine vane may confront the first plug. The portion of the platform of the turbine vane may confront the first plug so that the portion of the platform engages the first plug when the first plug begins to move out of the first installation aperture to block complete axial removal of the first plug out of the first installation aperture in the carrier segment.

In some embodiments, the platform of the turbine vane may include an outer end wall and a flange. The outer end wall may extend circumferentially and axially away from the airfoil to define the portion of the gas path of the turbine assembly. The flange may extend axially forward from the outer end wall toward the turbine shroud assembly radially outward of the gas path. The flange may confront the first plug so that the flange engages the first plug when the first plug begins to move out of the first installation aperture to block complete axial removal of the first plug out of the first installation aperture in the carrier segment.

In some embodiments, the mount assembly may further include a second retainer and a second plug. The second retainer may extend axially into the blade track segment and the carrier segment to couple the blade track segment to the carrier segment. The second plug may be fit into a second installation aperture in the carrier segment to block removal of the second retainer through the second installation aperture in the carrier segment. The second retainer may be spaced apart circumferentially from the first retainer. The flange of the platform may extend circumferentially at least partway about the axis and confronts the second plug so that the flange engages the second plug when the second plug begins to move out of the second installation aperture to block complete axial removal of the second plug out of the second installation aperture in the carrier segment.

In some embodiments, the first plug may include a head and a shaft. The head may engage the carrier segment to locate the first plug relative to the first retainer. The shaft may extend axially from the head into the first installation aperture in the carrier segment to block removal of the first retainer through the first installation aperture.

In some embodiments, the first retainer may have a first diameter. The shaft of the first plug may have a second diameter. The second diameter may be greater than the first diameter of the first retainer.

In some embodiments, the carrier segment may include an outer wall, a forward support wall that extends radially inward from the outer wall axially forward of the first attachment flange, an aft support wall that extends radially inward from the outer wall axially aft of the second attachment flange. The aft support wall of the carrier segment may include an axially-extending wall member that extends axially inward from the outer wall and a wall boss that extends axially aft away from the axially-extending wall member. The head of the first plug may engage the wall boss to space the head of the first plug axially away from an axially aft facing surface of the axially-extending wall member.

In some embodiments, the head of the first plug may have a rectangular cross-section. The shaft of the first plug may have a circular cross-section.

In some embodiments, the blade track segment may include a shroud wall that extends circumferentially partway around the axis, a first attachment flange that extends radially outward from the shroud wall, and a second attachment flange that extends radially outward from the should wall. The second attachment flange may be spaced apart axially from the first attachment flange.

In some embodiments, the carrier segment may include an outer wall, a forward support wall, an aft support wall, a first intermediate support wall, and a second intermediate support wall. The forward support wall may extend radially inward from the outer wall axially forward of the first attachment flange. The aft support wall may extend radially inward from the outer wall axially aft of the second attachment flange. The first intermediate support wall may extend radially inward from the outer wall of the carrier segment axially aft of the first attachment flange so that the first attachment flange is located axially between the forward support wall and the first intermediate support wall. The second intermediate support wall may extend radially inward from the outer wall of the carrier segment axially forward of the second attachment flange so that the second attachment flange is located axially between the aft support wall and the second intermediate support wall.

In some embodiments, the first retainer may include a first pin and a second pin arranged axially aft of the first pin. The first pin may extend axially into the forward support wall, through the first attachment flange, and through the first intermediate support wall. The second pin may extend axially through the second intermediate support flange, through the second attachment flange, and into the aft support wall.

According to another aspect of the present disclosure, a method may include providing a blade track segment. The blade track segment may include a shroud wall shaped to extend partway around an axis, a first attachment flange that extends radially outward from the shroud wall, and a second attachment flange spaced apart axially from the first attachment flange that extends radially outward from the shroud wall.

In some embodiments, the method may further include providing a carrier segment. The carrier segment may include an outer wall, a first support wall that extends radially inward from the outer wall, and a second support wall spaced apart axially from the first support wall that extends radially inward from the outer wall.

In some embodiments, the method may further include providing a mount system. The mount system may include a retainer and a plug.

In some embodiments, the method may further include providing a turbine vane. The turbine vane may include an airfoil that extends radially and a platform that extends circumferentially and axial away from the airfoil.

In some embodiments, the method may further include arranging the blade track segment adjacent the carrier segment so that the first attachment flange and the second attachment flange are located axially between the first support wall and the second support wall of the carrier segment. In some embodiments, the method may further include inserting the retainer through an installation aperture formed in the second support wall, through the second attachment flange and the first attachment flange, and into the first support wall to couple the blade track segment to the carrier segment.

In some embodiments, the method may further include inserting the plug into the installation aperture axially aft of the retainer to block removal of the retainer through the installation aperture in the carrier segment. In some embodiments, the method may further include arranging the turbine vane axially aft of the assembled blade track segment and the carrier segment so that a portion of the platform of the turbine vane confronts the plug so that the portion of the platform engages the plug when the plug begins to move out of the installation aperture to block complete axial removal of the plug out of the installation aperture in the carrier segment.

In some embodiments, the platform of the turbine vane may include an outer end wall and a flange. The outer end wall may extend circumferentially and axially away from the airfoil. The flange may extend axially forward from the outer end wall toward the assembled blade track segment and the carrier segment and confronts the plug.

In some embodiments, the plug may include a head and a shaft. The head may engage the carrier segment when inserted into the installation aperture to locate the plug relative to the retainer. The shaft may extend axially from the head into the installation aperture in the carrier segment when inserted into the installation aperture to block removal of the retainer through the installation aperture.

These and other features of the present disclosure will become more apparent from the following description of the illustrative embodiments.

### BRIEF DESCRIPTION OF THE DRAWINGS

FIG. 1 is a cut-away perspective view of a gas turbine engine showing that the exemplary engine includes a fan, a compressor, a combustor, and a turbine and suggesting that the turbine includes turbine wheel assemblies and static vane assemblies surrounded by a turbine shroud assembly;

FIG. 2 is a partial cross-sectional view of the gas turbine engine of FIG. 1 showing a portion of the turbine in which the turbine shroud assembly is located radially outward from blades of a turbine wheel assembly to block gasses from passing over the blades without interacting with the blades and one of the static turbine vanes is located axially aft of the turbine shroud assembly to direct the gasses into downstream rotating turbine wheel assemblies, and further showing the turbine shroud assembly includes a blade track segment made from ceramic matrix composite materials, a carrier segment made of metallic materials, and a mount assembly that extends axially into the blade track segment and the carrier segment to couple the blade track segment to the carrier segment;

FIG. 3 is a perspective view of a portion of the turbine shroud assembly of FIG. 2 showing the turbine vane includes an airfoil that extends radially across the gas path of the turbine and a platform that extends away from the airfoil to define a portion of the gas path of the turbine assembly, and further showing a portion of the platform of the turbine vane extends away from the airfoil toward the turbine shroud assembly to confront the mount system of the turbine shroud segment so that the portion of the platform engages the first plug when the first plug begins to move out of the first installation aperture to block complete axial removal of the first plug out of the first installation aperture in the carrier segment;

FIG. 4 is an exploded view of the turbine shroud assembly of FIG. 3 showing, from top to bottom, the turbine shroud assembly includes the carrier segment, the blade track segment, and the mount assembly having two retainers configured to extend radially through the carrier and the blade track segment to couple the blade track segment to the carrier and two plugs configured to be press fit into installation apertures in the carrier segment to block removal of the retainers;

FIG. 5 is a cross-sectional view of the turbine shroud assembly of FIG. 3 showing the platform of the turbine vane includes an outer end wall that extends circumferentially and axially away from the airfoil to define the portion of the gas path of the turbine assembly and a flange that extends axially forward from the outer end wall toward the turbine shroud assembly radially outward of the gas path and confronts the plugs to block axial removal of the plugs out of the installation apertures in the carrier segment; and

FIG. 6 is a cross-sectional view of the turbine shroud assembly of FIG. 3 showing the flange of the platform extends circumferentially so that a terminal end of the flange of the platform confronts both plugs to block axial removal of the plugs out of the installation apertures in the carrier segment.

### DETAILED DESCRIPTION OF THE DRAWINGS

For the purposes of promoting an understanding of the principles of the disclosure, reference will now be made to a number of illustrative embodiments illustrated in the drawings and specific language will be used to describe the same.

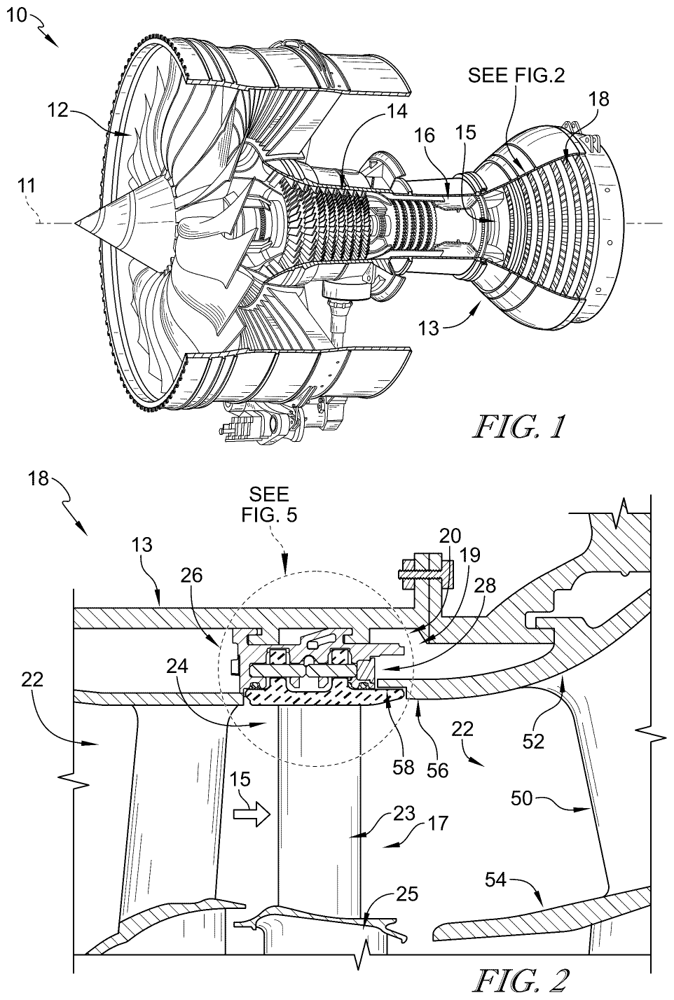

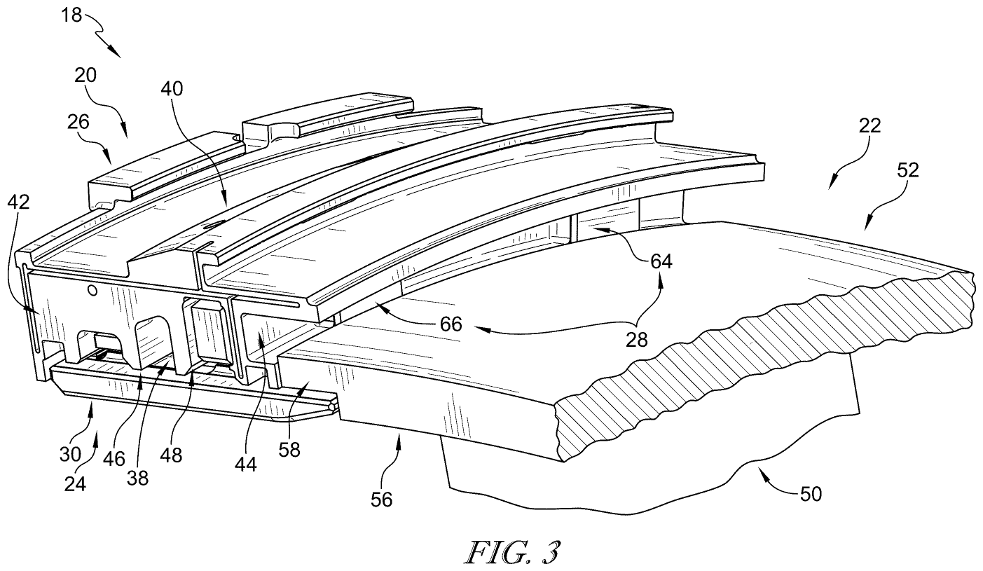

A turbine assembly 18 adapted for use in a gas turbine engine 10 is shown in FIGS. 1 and 2. The turbine assembly 18 includes a turbine shroud segment 20 and a turbine vane 22 located axially aft of the turbine shroud segment 20 as shown in FIGS. 2-6.

The turbine shroud segment 20 includes a blade track segment 24 made of ceramic matrix composite materials, a carrier segment 26 made of metallic materials, and a mount system 28 as shown in FIGS. 2-6. The blade track segment is arranged circumferentially at least partway around an axis 11 of the gas turbine engine 10. The carrier segment 26 is arranged circumferentially at least partway around the axis 11. The mount system 28 configured to couple the blade track segment 24 to the carrier segment 26.

The mount system 28 includes at least one retainer 60, illustratively two retainers 60, 62 that each extend axially into the blade track segment 24 and the carrier segment 26 to couple the blade track segment 24 to the carrier segment 26. The retainers 60, 62 are inserted into the carrier segment 26 through installation apertures 70, 72 in the carrier segment 26. To block removal of the retainers 60, 62, the mount system 28 further includes plugs 64, 66 that are press fit into the corresponding installation aperture 70, 72 aft of the retainers 60, 62 to block removal of the retainers 60, 62 through the installation apertures 70, 72 in the carrier segment 26.

The plugs 64, 66 are press fit into the carrier segment 26 to prevent axial movement of the plugs 64, 66. However, another layer of retention for the mount system 28 may be desirable to prevent the plugs 64, 66 from moving out of the installation apertures 70, 72.

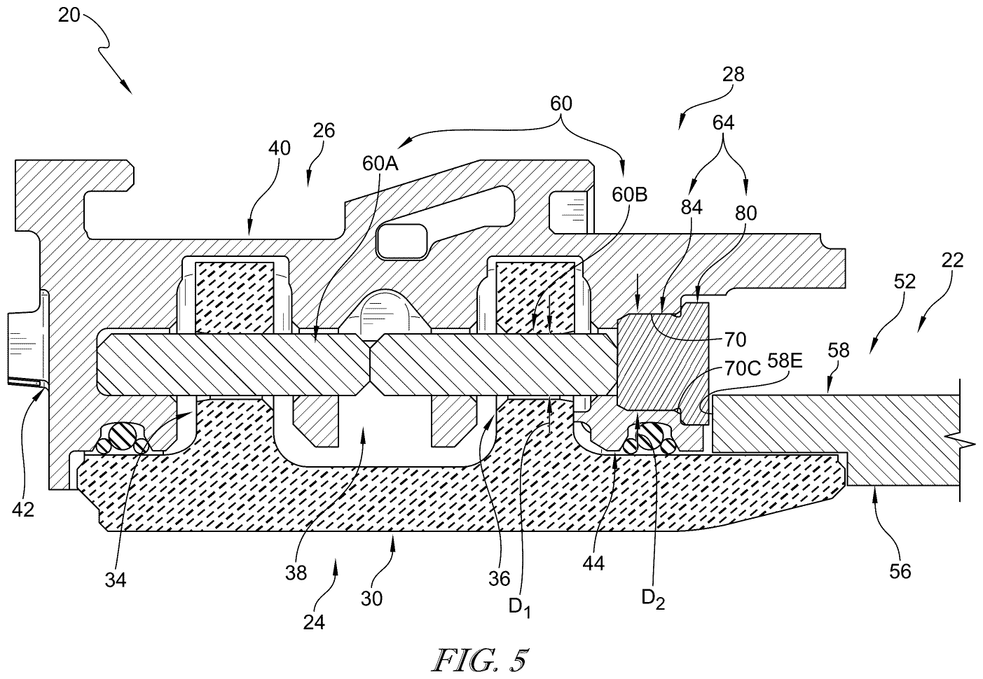

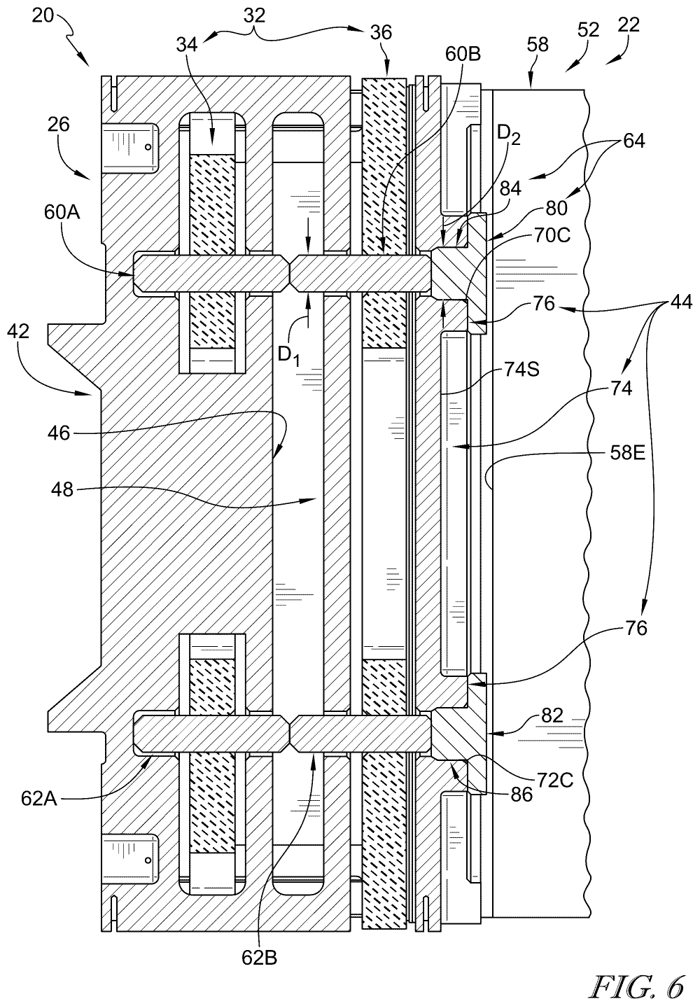

Therefore, a portion of the outer platform 52 of the turbine vane 22 extends toward the turbine shroud segment 20 to confront the plugs 64, 66 so that the portion of the outer platform 52 is adjacent to the plugs 64, 66, but does not engage the plugs 64, 66 as shown in FIGS. 5 and 6. The portion of the outer platform 52 confronts the plugs 64, 66 so that the portion of the platform 52 will engage the plugs 64, 66 when the plugs 64, 66 begin to move out of the first installation aperture 70, 72 to block complete axial removal of the plugs 64, 66 out of the first installation aperture 70, 72 in the carrier segment 26.

The portion of the outer platform 52 confronts the plugs 64, 66 to provide a redundant layer of retention for the retainers 60, 62. If the plugs 64, 66 loose the interference fit with the carrier segment 26, the portion of the outer platform 52 engages the plugs 64, 66 to block complete axial removal of the plugs 64, 66 out of corresponding installation aperture 70, 72 in the carrier segment 26. This prevents total removal of the plugs 64, 66 out of the respective installation apertures 70, 72.

In the illustrative embodiment, the portion of the outer platform 52 confronts the plugs 64, 66 so that there is a relatively small axial gap therebetween as shown in FIGS. 5 and 6. The term “confronts” means that the portion of the outer platform 52, or flange 58, does not engage the plugs 64, 66 when the plugs 64, 66 are properly press fit or interference fit in the installation apertures 70, 72. The portion of the outer platform 52 confronts the plugs 64, 66 so that the portion of the outer platform 52 is adjacent to the plugs 64, 66, but does not engage the plugs 64, 66. The gap is small enough so that the portion of the outer platform 52 will engage the plugs 64, 66 when the plugs 64, 66 begin to lose the interference fit and move out of the first installation aperture 70, 72. In some embodiments, the portion of the outer platform 52 may engage the plugs 64, 66 at all times.

The turbine vane 22 includes an airfoil 50, the outer platform 52, and an inner platform 54 spaced apart radially from the outer platform 52 as shown in FIGS. 2-6. The airfoil 50 extends radially across the gas path 15 of the turbine section 18. The outer and inner platforms each extend away from the airfoil 50 to define a portion of the gas path 15 of the turbine assembly 18.

A portion of the outer platform 52 confronts the plugs 64, 66 as shown in FIGS. 2-6. The portion of the outer platform 52 of the turbine vane 22 extends away from the airfoil 50 toward the turbine shroud assembly and confronts the plugs 64, 66. The portion of the outer platform 52 engages the plugs 64, 66 to block axial removal of the plugs 64, 66 out of the installation apertures 70, 72 in the carrier segment 26.

The outer platform 52 of the turbine vane 22 includes an outer end wall 56 and a flange 58 as shown in FIGS. 2-6. The outer end wall 56 extends circumferentially and axially away from the airfoil 50 to define the portion of the gas path 15 of the turbine assembly 18. The flange 58 extends axially forward from the outer end wall 56 toward the turbine shroud assembly 20 radially outward of the gas path 15 and confronts the plugs 64, 66 so that the flange 58 is adjacent to the plugs 64, 66, but does not engage the plugs 64, 66. The gap is small enough so that the flange 58 will engage the plugs 64, 66 when the plugs 64, 66 begin to move out of the first installation aperture 70, 72 to block axial removal of the plugs 64, 66 out of the installation apertures 70, 72 in the carrier segment 26.

Turning again to the gas turbine engine 10, the gas turbine engine 10 includes a fan 12, a compressor 14, a combustor 16, and a turbine 18 as shown in FIG. 1. The fan 12 is driven by the turbine 18 and provides thrust for propelling an air vehicle. The compressor 14 compresses and delivers air to the combustor 16. The combustor 16 mixes fuel with the compressed air received from the compressor 14 and ignites the fuel. The hot, high-pressure products of the combustion reaction in the combustor 16 are directed into the turbine 18 to cause the turbine 18 to rotate about an axis 11 and drive the compressor 14 and the fan 12. In some embodiments, the fan may be replaced with a propeller, drive shaft, or other suitable configuration.

The turbine section 18 includes at least one turbine wheel assembly 17, a turbine shroud 19 positioned to surround the turbine wheel assembly 17, and a turbine vane assembly 21 as shown in FIGS. 1 and 2. The turbine wheel assembly 17 includes a plurality of blades 23 coupled to a rotor disk 25 for rotation with the disk 25. The hot, high pressure combustion products from the combustor 16 are directed toward the blades 23 of the turbine wheel assemblies 17 along the gas path 15. The turbine shroud 19 is coupled to an outer case 13 of the gas turbine engine 10 and extends around the turbine wheel assembly 17 to block gases from passing over the turbine blades 23 during use of the turbine section 18 in the gas turbine engine 10. The turbine vane assemblies 21 include turbine vanes 22 configured to direct the gasses into downstream rotating turbine wheel assemblies 17.

In the illustrative embodiment, the turbine shroud 19 is made up of a number of turbine shroud assemblies 20 that each extend circumferentially partway around the axis 11 and cooperate to surround the turbine wheel assembly 17. In other embodiments, the turbine shroud 19 is annular and non-segmented to extend fully around the central axis 11 and surround the turbine wheel assembly 17. In yet other embodiments, certain components of the turbine shroud 19 are segmented while other components are annular and non-segmented.

Each turbine shroud assembly 20 includes the blade track segment 24, the carrier segment 26, and the mount system 28 as shown in FIGS. 2-6. The blade track segment 24 and the carrier segment 26 are arranged circumferentially partway about the axis 11. The mount system 28 is configured to couple the blade track segment 24 to the carrier segment 26.

The blade track segment includes a shroud wall 30 and an attachment feature 32 as shown in FIGS. 2-6. The shroud wall 30 that extends circumferentially partway around the axis 11. The attachment feature 32 includes a first attachment flange 34 and a second attachment flange 36 that each extend radially outward from the shroud wall. The second attachment flange 36 is spaced apart axially from the first attachment flange 34.

The carrier segment includes an outer wall 40, a pair of hangers 41, a forward support wall 42, and an aft support wall 44 as shown in FIGS. 2-6. The outer wall extend circumferentially at least partway about the axis 11. The hangers 41 extend radially outward from the outer wall 40 and engage the case 17 to couple the turbine shroud segment 22 to the rest of the engine 10

The forward support wall 42 extends radially inward from the outer wall axially forward of the first attachment flange 34. The aft support wall 44 extends radially inward from the outer wall 40 axially aft of the second attachment flange 36. The outer wall 40 of the carrier segment 26 is spaced radially outward of the attachment feature 32 of the blade track segment 24 to define a chamber 38 radially between the carrier segment 26 and the blade track segment 24.

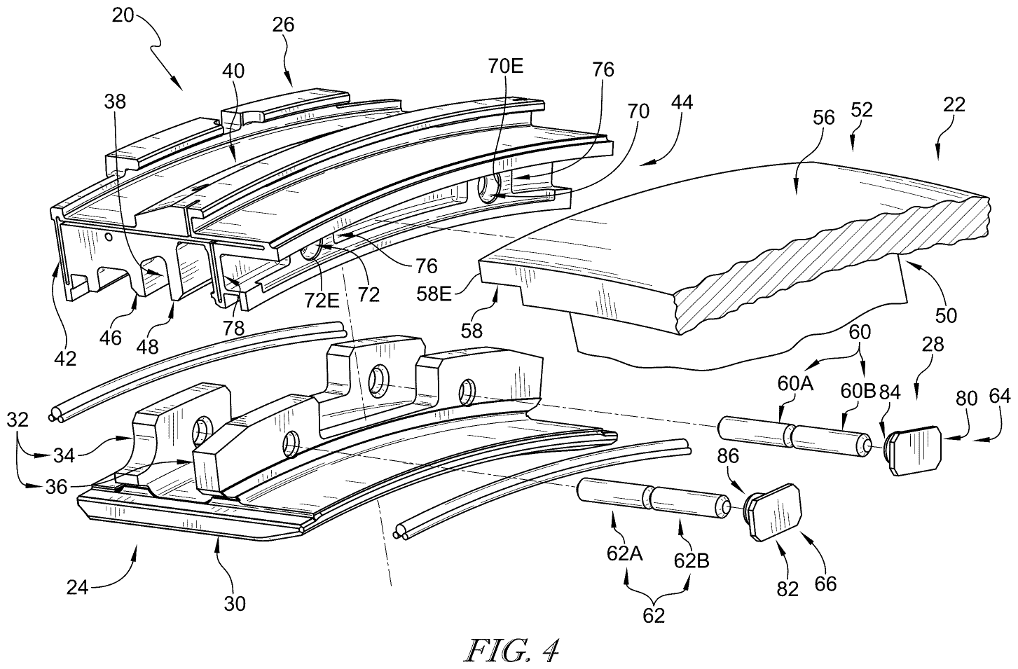

The aft support wall 44 of the carrier segment 26 includes an axially-extending wall member 74 and wall bosses 76 as shown in FIGS. 4 and 5. The axially-extending wall member 74 extends axially inward from the outer wall 40. Each wall boss 76 extends axially aft away from the axially-extending wall member 74. Each of the plugs 64, 66 engages the respective wall boss 76 to space a head 80, 82 of the each plug 64, 66 axially away from an axially aft facing surface 74S of the axially-extending wall member 74.

In the illustrative embodiment, the installation apertures 70, 72 extend axially through the aft support wall 44 at each of the wall bosses 76. Each installation aperture 70, 72 includes a chamfer surface 70C, 72C as shown in FIGS. 4-6. Each chamfer surface 70C, 72C faces the respective plug 64, 66.

In the illustrative embodiment, the carrier segment 26 further includes a first intermediate support wall 46 and a second intermediate support wall 48 as shown in FIGS. 2-6. The first intermediate support wall 46 and the second intermediate support wall 48 each extend radially inward from the outer wall 40 of the carrier segment 26.

The first intermediate support wall 46 extends radially inward from the outer wall 40 axially aft of the first attachment flange 34 of the blade track segment 24 so that the first attachment flange 34 is located in a forward space between the forward support wall 42 and the first intermediate support wall 46. The second intermediate support wall 48 extends radially inward from the outer wall axially forward of the second attachment flange 36 of the blade track segment 24 so that the second attachment flange 36 is located in an aft space between the aft support wall 44 and the second intermediate support wall 48.

The second intermediate support wall 48 is spaced apart axially from the first intermediate support wall 46 to define the open space of the chamber 38. In the illustrative embodiment, the chamber 38 is defined between the first and second intermediate support walls 46, 48, the outer wall 40 of the carrier segment 26, and the shroud wall 30 of the blade track segment.

The mount system 28 includes a first retainer 60, a second retainer 62 spaced apart circumferentially from the first retainer 62, a first retainer plug 64 circumferentially aligned with the first retainer 60, and a second retainer plug 66 circumferentially aligned with the second retainer 62 as shown in FIGS. 2-6. Both the first and second retainers 60, 62 extend axially into the forward support wall 42, through the first attachment flange 34, the intermediate support walls 46, 48, and the second attachment flange 36, and into the aft support wall 44 of the carrier segment 26 so as to couple the blade track segment 24 to the carrier segment 26. Each of the retainer plugs 64, 66 extend into the installation apertures 70, 72 formed in the aft support wall 44 to block removal of the corresponding retainers 60, 62 through the installation apertures 70, 72.

In the illustrative embodiment, the first and second retainers 60, 62 are both split pins as shown in FIGS. 2 and 4. Each retainer 60, 62 includes a first pin 60A, 62A and a second pin 60B, 62B.

Each retainer 60, 62 has a first diameter D₁ and each shaft 78, 80 of the plugs 64, 66 has a second diameter D₂ as shown in FIG. 5. The second diameter D₂ is greater than the first diameter D₁ in the illustrative embodiment.

Each of the first and second plugs 64, 66 includes the head 80, 82 and a shaft 84, 86 as shown in FIGS. 4 and 5. The head 80, 82 engages the aft support wall 44 of the carrier segment 26 to locate the each plug 64, 66 relative to the corresponding retainer 60, 62. The head 80, 82 extends axially aft past the aft support wall 44 so that an end surface 80S, 82S is spaced axially aft of the aft support wall 44.

The shaft 84, 86 extends axially from the head 80, 82 into the corresponding installation aperture 70, 72 in the aft support wall 44 to block removal of the retainers 60, 62 through the installation apertures 70, 72.

In the illustrative embodiments, the head 80, 82 of each plug 64, 66 has a substantially rectangular cross-section, while the shaft 84, 86 of each plug 64, 66 has a circular cross-section. The rectangular cross-section of the head 80, 82 may make it easier to grip to remove the plugs 64, 66 from the carrier segment 26 in an event the retainers 60, 62 need to be replaced. In the illustrative embodiment, the outer edge of the head 80, 82 of each plug 64, 66 has chamfered corners as shown in FIG. 4.

The turbine vane 22 includes an airfoil 50, an outer platform 52, and an inner platform 54 spaced apart radially from the outer platform 52 as shown in FIGS. 2-6. The airfoil 50 extends radially across the gas path 15 of the turbine section 18. The outer and inner platforms each extend away from the airfoil 50 to define a portion of the gas path 15 of the turbine assembly 18.

A portion of the outer platform 52 confronts the turbine shroud assembly 20 as shown in FIGS. 2-6. The portion of the outer platform 52 of the turbine vane 22 extends away from the airfoil 50 toward the turbine shroud assembly and confronts the plugs 64, 66. The portion of the outer platform 52 confronts the plugs 64, 66 so that the portion of the outer platform 52 engages the plugs 64, 66 if the plugs 64, 66 begin to loose the interference fit so as to block complete axial removal of the plugs 64, 66 out of the installation apertures 70, 72 in the carrier segment 26.

The outer platform 52 of the turbine vane 22 includes an outer end wall 56 and a flange 58 as shown in FIGS. 2-6. The outer end wall 56 extends circumferentially and axially away from the airfoil 50 to define the portion of the gas path 15 of the turbine assembly 18. The flange 58 extends axially forward from the outer end wall 56 toward the turbine shroud assembly 20 radially outward of the gas path 15. The flange 58 confronts the head 80, 82 of the plugs 64, 66 to block axial removal of the plugs 64, 66 out of the installation apertures 70, 72 in the carrier segment 26.

In the illustrative embodiment, the flange 58 of the platform 52 extends circumferentially at least partway about the axis 11. The flange 58 extends circumferentially at least partway about the axis 11 so that the flange 58 confronts both plugs 64, 66. In some embodiments, the platform 52 may include multiple flanges 58 spaced apart circumferentially to confront each of the plugs 64, 66 individually.

A method of assembling and using the turbine shroud segment 20 may include several steps. To begin assembling the turbine shroud segment 20, the method includes arranging the blade track segment 24 adjacent the carrier segment 26 so that the first attachment flange 32 and the second attachment flange 34 are located axially between the first support wall 42 and the second support wall 44 of the carrier segment 26. The blade track segment 24 is arranged adjacent the carrier segment 26 so that holes in the attachment flanges 34, 36 align with the holes in the support walls 42, 44, 46, 48 of the carrier segment 26.

The method continues by inserting the first retainer 60 through the installation aperture 70 in the aft support wall 44, through the second attachment flange 36, through the intermediate support walls 46, 48, through the first attachment flange 34, and into the forward support wall 42 to couple the blade track segment 24 to the carrier segment 26. The method further includes inserting the second retainer 62 through the installation aperture 72 in the aft support wall 44, through the second attachment flange 36, through the intermediate support walls 46, 48, through the first attachment flange 34, and into the forward support wall 42 to couple the blade track segment 24 to the carrier segment 26.

The method may further include inserting the first retainer plug 64 into the installation aperture 70 and inserting the second retainer plug 66 into the installation aperture 72. The retainer plugs 64, 66 are inserted into the corresponding installation apertures 70, 72 to block removal of the retainers 60, 62.

Next, the turbine vane 22 is arranged adjacent to the assembled blade track segment 24 and the carrier segment 26 of the turbine shroud segment 20. The turbine vane 22 is arranged axially aft of the assembled blade track segment 24 and the carrier segment 26 so that flange 58 of the platform 52 confronts the plugs 64, 66 so that the platform 52 engages the plugs 64, 66 when either of the plugs 64, 66 begins to move out of the installation aperture 70, 72 to block complete axial removal of the plugs 64, 66 out of the installation aperture 70, 72 in the carrier segment 24.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

1. A turbine assembly adapted for use with a gas turbine engine, the turbine assembly comprising
a turbine shroud assembly comprising:
a blade track segment made of ceramic matrix composite materials and arranged circumferentially at least partway around an axis, the blade track segment including a shroud wall that extends circumferentially at least partway around the axis to define a portion of a gas path of the turbine assembly and an attachment feature that extends radially outward from the shroud wall,
a carrier segment made of metallic materials and arranged circumferentially at least partway around the axis, the carrier segment including an outer wall, a forward support wall that extends radially inward from the outer wall axially forward of the attachment feature, and an aft support wall that extends radially inward from the outer wall axially aft of the attachment feature, and
a mount assembly including a first retainer that extends axially into a first installation aperture formed in the aft support wall of the carrier segment, through the attachment feature, and into the forward support wall to couple the blade track segment to the carrier segment and a first plug press fit into the first installation aperture aft of the first retainer to block removal of the first retainer through the first installation aperture in the carrier segment, and
a turbine vane located axially aft of the turbine shroud assembly, the turbine vane including an airfoil that extends radially across the gas path of the turbine assembly and a platform that extends away from the airfoil to define a portion of the gas path of the turbine assembly,
wherein a portion of the platform of the turbine vane extends away from the airfoil toward the turbine shroud assembly to confront the first plug so that the portion of the platform engages the first plug when the first plug begins to move out of the first installation aperture to block complete axial removal of the first plug out of the first installation aperture in the carrier segment.

2. The turbine assembly of claim 1, wherein the platform of the turbine vane includes an outer end wall that extends circumferentially and axially away from the airfoil to define the portion of the gas path of the turbine assembly and a flange that extends axially forward from the outer end wall toward the turbine shroud assembly radially outward of the gas path and confronts the first plug so that the flange engages the first plug when the first plug begins to move out of the first installation aperture to block complete axial removal of the first plug out of the first installation aperture in the carrier segment.

3. The turbine assembly of claim 2, wherein the mount assembly further includes a second retainer that extends axially into a second installation aperture formed in the aft support wall of the carrier segment, through the attachment feature, and into the forward support wall and a second plug press fit into the second installation aperture aft of the second retainer to block removal of the second retainer through the second installation aperture in the carrier segment, the second retainer spaced apart circumferentially from the first retainer, and the flange of the platform extends circumferentially at least partway about the axis and confronts the second plug so that the flange engages the second plug when the second plug begins to move out of the second installation aperture to block complete axial removal of the second plug out of the second installation aperture in the carrier segment.

4. The turbine assembly of claim 1, wherein the first plug includes a head that engages the aft support wall of the carrier segment to locate the first plug relative to the first retainer and a shaft that extends axially from the head into the first installation aperture in the aft support wall to block removal of the first retainer through the first installation aperture.

5. The turbine assembly of claim 4, wherein the first retainer has a first diameter and the shaft of the first plug has a second diameter that is greater than the first diameter of the first retainer.

6. The turbine assembly of claim 4, wherein the aft support wall of the carrier segment includes an axially-extending wall member that extends axially inward from the outer wall and a wall boss that extends axially aft away from the axially-extending wall member, and wherein the head of the first plug engages the wall boss to space the head of the first plug axially away from an axially aft facing surface of the axially-extending wall member.

7. The turbine assembly of claim 4, wherein the head of the first plug has a rectangular cross-section and the shaft of the first plug has a circular cross-section.

8. The turbine assembly of claim 1, wherein the attachment feature of the blade track segment includes a first attachment flange that extends radially outward from the shroud wall and a second attachment flange that extends radially outward from the should wall and spaced apart axially from the first attachment flange,
wherein the carrier segment further includes a first intermediate support wall that extends radially inward from the outer wall of the carrier segment axially aft of the first attachment flange so that the first attachment flange is located in a forward space between the forward support wall and the first intermediate support wall and a second intermediate support wall that extends radially inward from the outer wall of the carrier segment axially forward of the second attachment flange so that the second attachment flange is located in an aft space between the aft support wall and the second intermediate support wall, and
wherein the first retainer extends into the aft support wall of the carrier segment, through the second attachment feature, the second intermediate support wall, the first intermediate support wall, the first attachment feature, and into the forward support wall to couple the blade track segment to the carrier segment.

9. The turbine assembly of claim 8, wherein the first retainer includes a forward pin that extends axially into the forward support wall, through the first attachment flange, and through the first intermediate support wall and an aft pin arranged axially aft of the forward pin that extends axially through the second intermediate support flange, through the second attachment flange, and into the aft support wall.

10. A turbine assembly adapted for use with a gas turbine engine, the turbine assembly comprising
a turbine shroud assembly including a blade track segment arranged circumferentially at least partway around an axis to define a portion of a gas path of the turbine assembly, a carrier segment arranged circumferentially at least partway around the axis, and a mount assembly configured to couple the blade track segment to the carrier segment, wherein the mount assembly includes a first retainer that extends axially into the blade track segment and the carrier segment to couple the blade track segment to the carrier segment and a first plug fit into a first installation aperture in the carrier segment to block removal of the first retainer through the first installation aperture in the carrier segment, and
a turbine vane located adjacent to the turbine shroud assembly, the turbine vane including an airfoil that extends radially across the gas path of the turbine assembly and a platform that extends away from the airfoil to define a portion of the gas path of the turbine assembly,
wherein a portion of the platform of the turbine vane confronts the first plug so that the portion of the platform engages the first plug when the first plug begins to move out of the first installation aperture to block complete axial removal of the first plug out of the first installation aperture in the carrier segment.

11. The turbine assembly of claim 10, wherein the platform of the turbine vane includes an outer end wall that extends circumferentially and axially away from the airfoil to define the portion of the gas path of the turbine assembly and a flange that extends axially forward from the outer end wall toward the turbine shroud assembly radially outward of the gas path and confronts the first plug so that the flange engages the first plug when the first plug begins to move out of the first installation aperture to block complete axial removal of the first plug out of the first installation aperture in the carrier segment.

12. The turbine assembly of claim 11, wherein the mount assembly further includes a second retainer that extends axially into the blade track segment and the carrier segment to couple the blade track segment to the carrier segment and a second plug fit into a second installation aperture in the carrier segment to block removal of the second retainer through the second installation aperture in the carrier segment, the second retainer spaced apart circumferentially from the first retainer, and the flange of the platform extends circumferentially at least partway about the axis and confronts the second plug so that the flange engages the second plug when the second plug begins to move out of the second installation aperture to block complete axial removal of the second plug out of the second installation aperture in the carrier segment.

13. The turbine assembly of claim 10, wherein the first plug includes a head that engages the carrier segment to locate the first plug relative to the first retainer and a shaft that extends axially from the head into the first installation aperture in the carrier segment to block removal of the first retainer through the first installation aperture.

14. The turbine assembly of claim 13, wherein the first retainer has a first diameter and the shaft of the first plug has a second diameter that is greater than the first diameter of the first retainer.

15. The turbine assembly of claim 13, wherein the carrier segment includes an outer wall, a forward support wall that extends radially inward from the outer wall axially forward of the first attachment flange, an aft support wall that extends radially inward from the outer wall axially aft of the second attachment flange,
wherein the aft support wall of the carrier segment includes an axially-extending wall member that extends axially inward from the outer wall and a wall boss that extends axially aft away from the axially-extending wall member, and
wherein the head of the first plug engages the wall boss to space the head of the first plug axially away from an axially aft facing surface of the axially-extending wall member.

16. The turbine assembly of claim 13, wherein the head of the first plug has a rectangular cross-section and the shaft of the first plug has a circular cross-section.

17. The turbine assembly of claim 10, wherein the blade track segment includes a shroud wall that extends circumferentially partway around the axis, a first attachment flange that extends radially outward from the shroud wall, and a second attachment flange that extends radially outward from the should wall, the second attachment flange spaced apart axially from the first attachment flange,
wherein the carrier segment includes an outer wall, a forward support wall that extends radially inward from the outer wall axially forward of the first attachment flange, an aft support wall that extends radially inward from the outer wall axially aft of the second attachment flange, a first intermediate support wall that extends radially inward from the outer wall of the carrier segment axially aft of the first attachment flange so that the first attachment flange is located axially between the forward support wall and the first intermediate support wall, and a second intermediate support wall that extends radially inward from the outer wall of the carrier segment axially forward of the second attachment flange so that the second attachment flange is located axially between the aft support wall and the second intermediate support wall, and
wherein the first retainer includes a first pin that extends axially into the forward support wall, through the first attachment flange, and through the first intermediate support wall and a second pin arranged axially aft of the first pin that extends axially through the second intermediate support flange, through the second attachment flange, and into the aft support wall.

18. A method comprising
providing a blade track segment including a shroud wall shaped to extend partway around an axis, a first attachment flange that extends radially outward from the shroud wall, and a second attachment flange spaced apart axially from the first attachment flange that extends radially outward from the shroud wall,
providing a carrier segment including an outer wall, a first support wall that extends radially inward from the outer wall, and a second support wall spaced apart axially from the first support wall that extends radially inward from the outer wall,
providing a mount system including a retainer and a plug,
providing a turbine vane including an airfoil that extends radially and a platform that extends circumferentially and axial away from the airfoil,
arranging the blade track segment adjacent the carrier segment so that the first attachment flange and the second attachment flange are located axially between the first support wall and the second support wall of the carrier segment,
inserting the retainer through an installation aperture formed in the second support wall, through the second attachment flange and the first attachment flange, and into the first support wall to couple the blade track segment to the carrier segment,
inserting the plug into the installation aperture axially aft of the retainer to block removal of the retainer through the installation aperture in the carrier segment, and
arranging the turbine vane axially aft of the assembled blade track segment and the carrier segment so that a portion of the platform of the turbine vane confronts the plug so that the portion of the platform engages the plug when the plug begins to move out of the installation aperture to block complete axial removal of the plug out of the installation aperture in the carrier segment.

19. The method of claim 18, wherein the platform of the turbine vane includes an outer end wall that extends circumferentially and axially away from the airfoil and a flange that extends axially forward from the outer end wall toward the assembled blade track segment and the carrier segment and confronts the plug.

20. The method of claim 18, wherein the plug includes a head that engages the carrier segment when inserted into the installation aperture to locate the plug relative to the retainer and a shaft that extends axially from the head into the installation aperture in the carrier segment when inserted into the installation aperture to block removal of the retainer through the installation aperture.
